(19) United States
(12) Patent Application Publication
(10) Pub. No.: US 2006/0268221 A1
(43) Pub. Date: Nov. 30, 2006

(54) Eyewear retention device

(76) Inventor: Michael Tracy, New York, NY (US)

Correspondence Address: Robert Gorman, Esq.;Gorman Associates, Law Offices, Suite 449, 305 Madison Avenue, New York, NY, 10165, US

(21) Appl. No.: 11/220,325

(22) Filed: Sep. 6, 2005

Related U.S. Application Data
(63) Continuation-in-part of application No. 11/140,831, filed on May 31, 2005.

(51) Int. Cl. G02C 3/00

(52) U.S. Cl. 351/155

(57) ABSTRACT

An eyeglass retention device that allows eyewear to be securely worn and alternately securely retained on headwear. This device provides the above in a sporty, practical, yet low profile manner for all types of eyewear users, and with all types of headwear.

### RELATED APPLICATIONS

The present invention is a Continuation-In-Part of U.S. patent application Ser. No. 11/140,831, filed May 31, 2005, the entirety of which is hereby incorporated by reference.

### BACKGROUND OF THE INVENTION

1. Field of the Invention

The present invention relates to an eyewear retention device which allows eyewear such as eyeglasses, sunglasses or goggles, when not in direct use, to be worn in a set position on head gear or headwear such as caps, baseball caps, helmets, etc. without falling off or being lost or damaged.

2. Description of the Related Art

Many people wear eyewear, such as prescription eyeglasses, sunglasses, goggles, etc. for sports, work, reading, eye protection, or for fashion purposes. However, normal use of eyewear is problematic as it often gets lost, broken, misplace, or falls off a user. For example, in some cases eyewear may be kept in a pocket or handbag. However, carrying eyewear in a pocket or handbag has the disadvantage that people frequently forget where they have placed their glasses and are unable to reach them when necessary. Such carrying also causes breakage and loss. The glasses may be accidentally dropped upon taking them out of the pocket or handbag.

Alternatively, it is also common to see people carrying their glasses hanging down on their chests, by means of a simple strap, string or cord with clips at either end attached to the frame of the glasses. However, such straps or cords are inconvenient or easily forgotten behind when using eyewear of different types. Furthermore, having loose eyeglass cords or hanging eyewear or eyeglasses from the neck is quite inconvenient, given that the straps sway, may be snagged, and in general are a hindrance to movement. Moreover, when engaging in sports or otherwise intense movements, glasses hanging from the neck sway and/or flop about with each movement of the body. Additionally, the glass can break and cause injury if one should accidentally fall down. As such, it is common to see people wear their eyewear perched on their headgear, but of course, this too is problematic as it often leads to breakage or loss when the glasses fall off the headwear, or lost when they are placed aside somewhere so as not to fall off the headgear. Despite these severe drawbacks, prior approaches to securing glasses in various ways leaves much to be desired. By way of a few examples, U.S. Pat. No. 6,637,074 (Morris) teaches a cumbersome “hat fastener” that, inter alia, is deficient in that it does not offer a convenient way to secure glasses both on the face and off, while U.S. Pat. No. 5,898,472 (Oshikawa) provides something termed an “eyewear strap winding device” that, in addition to being some kind of bulky, awkward reel device which requires a user to try and reach around behind the head for adjustment, clearly offers no means of eliminating loose strings and/or maintaining a constant tension that can press eyewear against the surface against which it is set (something which is extremely beneficial, particularly when worn on say, a sweaty nose during sports or whether worn on headwear during intense periods of movement). In these regards and many others, none of the prior art solutions offer a way to avoid the above-described problems.

### SUMMARY OF THE INVENTION

It is therefore an object of the present invention, among others, to overcome deficiencies in the prior art such as noted above.

It is also an object of the present invention to provide an eyewear retention device that is convenient to use consistently, easily retained, and offers a practical yet sporty, low-type profile for daily use. In this regard, the present invention permits carrying of eyewear by retaining them around the face with a constant tension, but also allows setting and resetting of the eyewear on the headwear to be performed with a single swift movement. It causes little or no hindrance during activities such as sports, is fashionable, highly durable, can be produced at low cost, and its operation can easily be controlled. The invention may be used on all manner of head wear or headgear, whether it be hunting hats, baseball caps, helmets, hardhats, sun visors, or any other type of head gear. The invention may also be used for all manner of eyewear, whether it be prescription eyeglasses, sunglasses, safety glasses, goggles, etc.

Additional objects, advantages and other novel features of the invention will be set forth in part in the description that follows and in part will become apparent to those skilled in the art upon examination of the following or may be learned with the practice of the invention.

### BRIEF DESCRIPTION OF THE DRAWINGS

The accompanying drawings, which are incorporated in and constitute a part of the specification, illustrate a preferred embodiment of the invention and, together with the general description given above, and the detailed description of the preferred embodiment given below, serve to explain the principles of the invention.

FIG. 1 is a side view of user wearing eyewear and headwear, and utilizing an embodiment of the invention while wearing said eyewear;

FIG. 2 is a side offset view of user wearing eyewear and headwear, and utilizing an embodiment of the invention while resting said eyewear on said headwear;

FIGS. 3(a)-(d) are collectively perspective views of various stages of employment of the present invention with eyewear and headgear, as used by the wearer from when on his face to removing from said face, pulling out and rotating up toward rest on said headgear;

FIG. 4 is a perspective view showing the full range of rotational movement that the installed device is capable of, relative to a vertical plane laterally bisecting exemplary headgear;

FIGS. 5(a)-(c), FIG. 5(a) is a side, offset view of one embodiment of the invention, a contiguous lateral double barrel version detached from exemplary headgear, and as secured by a clip means, while FIG. 5b is an exemplary positioning of the device in with illustrative head gear and eyewear, and 5(c) is an illustration of an alternative embodiment of utilizing a bifurcated version having separated multiple barrel left and right segments;

FIG. 6 is a side, offset exterior and ghosted interior perspective view of one embodiment of the invention, as situated on the inside of exemplary headgear, and might be secured by either a clip, headgear material integrated type structure, or hook and loop fastener; and

FIGS. 7(a)-(c) are side, offset views of various possible embodiments of the eyeglass frame attachment portion of the invention, as attached to exemplary eyewear.

### DETAILED DESCRIPTION OF THE PREFERRED EMBODIMENTS

In its broadest embodiment, the present invention relates to an eyewear retention device comprising a stretchable module having a left end and a right end, an eyewear frame attachment portion at the left and at the right end for attachment to an article of eyewear (glasses, goggles, etc.) and at least one anchoring module for anchoring the stretchable module to an article of headwear. In one embodiment, the retention device further comprises a containment module, such as plastic tubing, for housing the stretchable module, wherein the stretchable module is constrained within said containment module so as to permit various levels of tensioning and stretching of the stretchable module. The retention device is set on or within an item of headwear by an anchoring module 11 that is formed from clips, headwear integrated structures (e.g., for placement within brims, bands, etc., within given headwear), or hook and loop fasteners so as to be either permanent (integral) or added on (removable from) headwear. In one preferred embodiment, the stretchable module will have at least one, and preferably, two stretchable element(s) is formed from a bungee type material.

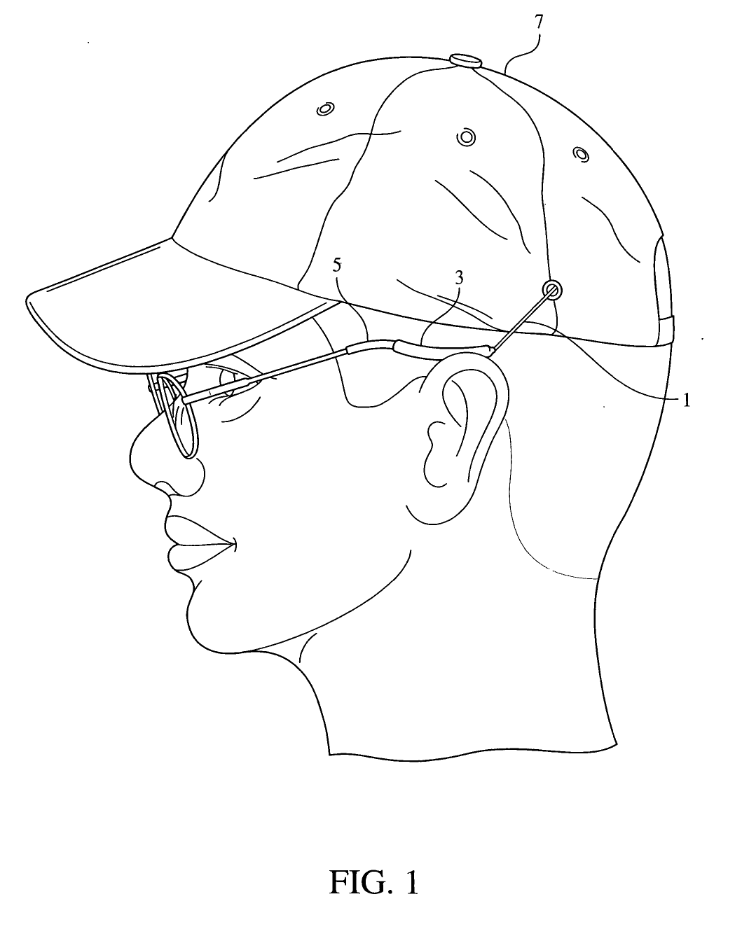

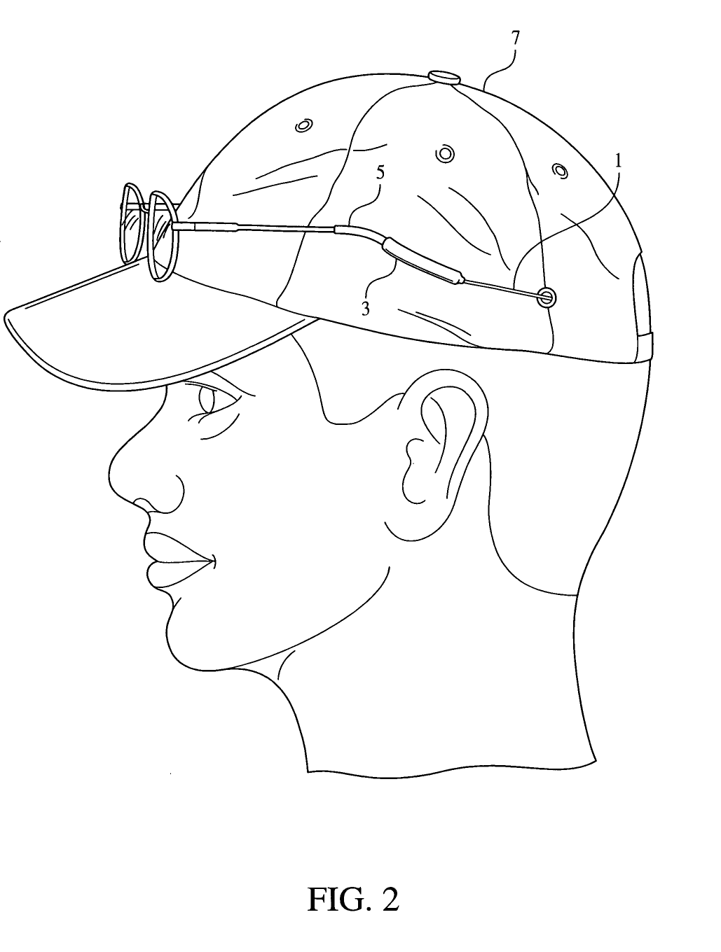

Reference will now be made in detail to the present preferred embodiment of the invention as illustrated in the accompanying drawings. FIG. 1 is a side view of user wearing eyewear 5 and headwear 7, and utilizing an embodiment of the invention while wearing eyewear, which is, in one embodiment (as currently depicted in FIG. 1) largely embedded or affixed inside or integral to headwear 7, so as to provide a fashion forward, low profile, which offers a practical, convenient alternative to messy, awkward and/or clumsy strings as known in the prior art, and to further offer an alternative to perching eyewear on headgear in an unsecured fashion, and/or to prevent loss due to misplaced eyewear. FIG. 2 is a side offset view of the same exemplary embodiment seen in FIG. 1 above, but with the user utilizing the invention while resting eyewear 5 on headwear 7 in a secured fashion that prevents loss, falls, or breakage that typically occurs when one moves, bends over, etc., at a time when the user has perched or rested eyewear on headgear, or when user removes the eyewear in an attempt to prevent the same.

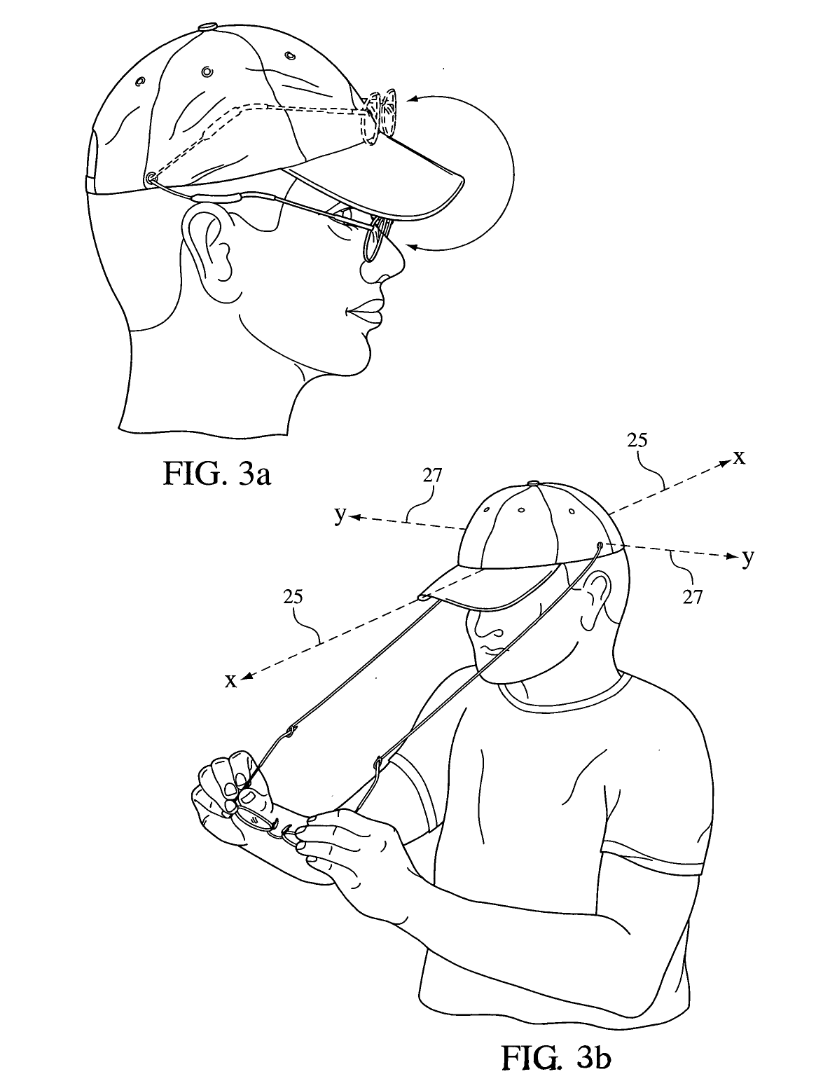

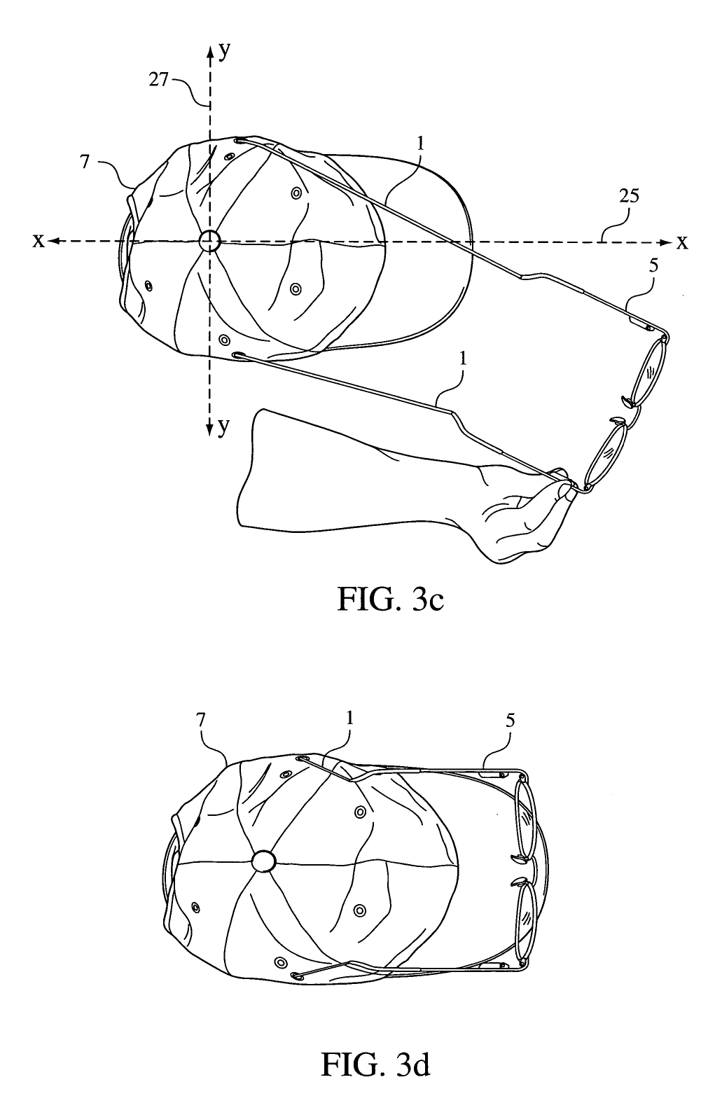

FIGS. 3(a)-(d) are several perspective views of various stages of employment of the present invention along with eyewear 5 and headgear 7. FIG. 3(a) shows the wearer employing the invention so that eyewear 5 is securely situated on his face in FIG. 3(a), while FIG. 3(b) depicts him removing eyewear 5 from his face and lastly, FIGS. 3(c) and 3(d) respectively show a top-down view of an exemplary pulling out and rotating up eyewear 5 in towards a resting position headgear 7. Note that all times, whether in the stages depicted in FIGS. 3(a), 3(b), 3(c), or 3(d), the stretchable module 9 provides, in a preferred embodiment, a fairly constant, omnipresent tension back (e.g. inward) along cords 1 back towards tubing 1′ of stretchable module 9, thereby helping secure the eyewear from falling off a user's face, or headwear 7. In addition, this constant tension (despite any minor fluctuations that may result at the extreme lengths of elongation of a given material) provides a substantially constant force that renders the cords snag-free, and helps the user to easily and rapidly guide into place eyewear 5 onto headwear 7, or alternatively, onto his face with minimal effort. This is particularly desirable for athletes who may need to rapidly remove or affix eyewear with only one hand, or while in motion. As further seen in FIG. 3(b), axis x at 25 aligns a vertical plane that might laterally bisect exemplary headgear 7. In the normal range of usage, the cord(s) 1 extend from and retract back into stretchable module 9 in a way that is typically roughly parallel to axis x at 25 (more or less depending on the actual width of eyewear 5), and as will be detailed hereafter, will also typically rotate about a center axis y at 27. However, it is also important to note that cord(s) 1 are flexible, if necessary, can deviate significantly from said parallel movement about axis x at 25, as indicated in the exemplary flexible range of movement exhibited in FIG. 3(c). This flexibility, combined with the substantially even inward tension throughout, allows for more realistic usage by active users such as athletes or others who may need to reset the resting position of their eyewear with just one hand, or while in motion.

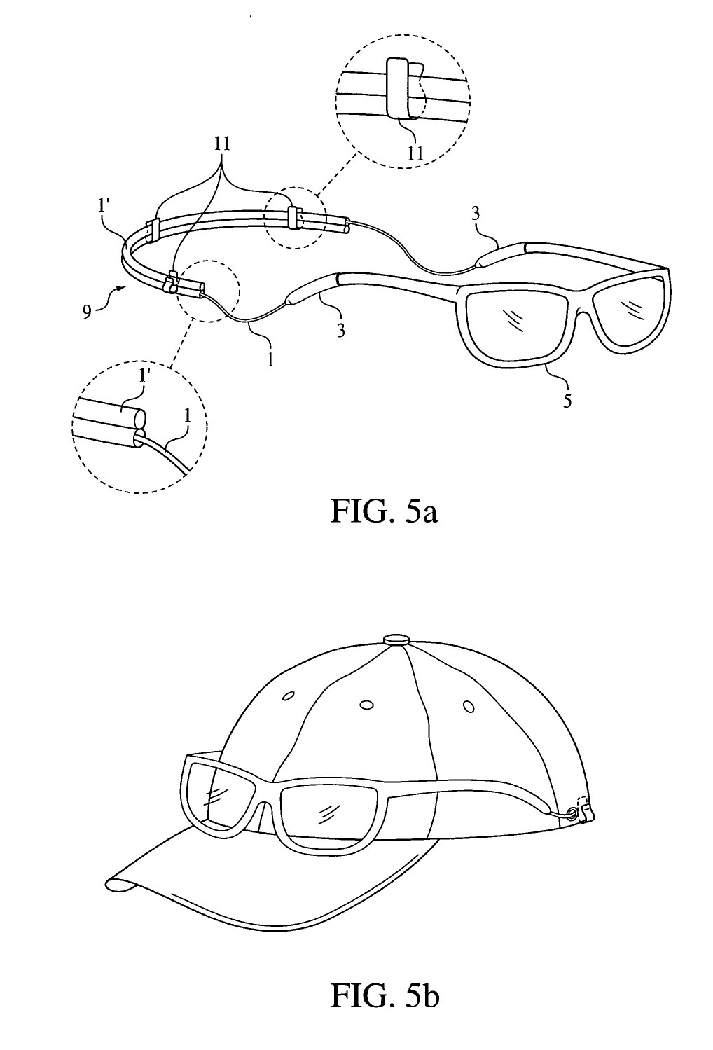

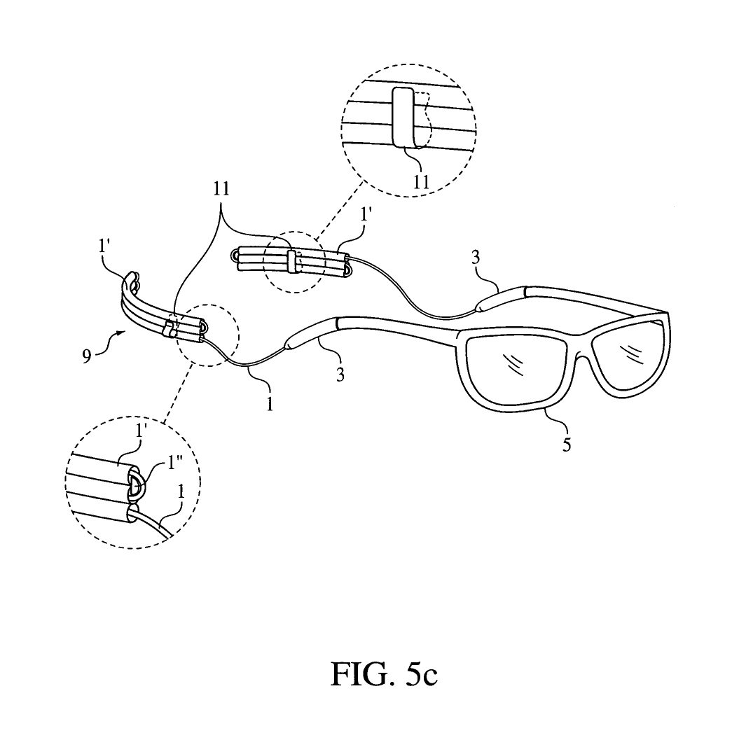

The present invention, therefore is to provide at least one stretchable module 9, comprising at least one stretchable element or cord 1 (having a left and a right end), and in an especially preferred embodiment, two separate stretchable elements or cords 1 (also having a right end and a left end respectively) cord(s) 1 that may be clipped, velcroed, tied, sewn, embedded, anchored, or otherwise affixed on an exterior or interior surface of at least each side of the headwear, such that the cord(s) 1 are allowed to be stretched out when the user brings the eyewear over the user's face and/or a brim of headwear 7 to wear the eyewear 5, and retracts when glasses are rested back on headwear 7. However, it is important to note that in the case of the stretchable module 9 having two stretchable elements or cords 1 as illustrated in FIG. 5a. One alternate embodiment, seen in FIG. 5(c), might be to structure module 9 so as to be bifurcated, and so as to have separate left and right units having shorter lengths of cords 1. Such structure might have say, shorter tubing 1′ (e.g., containment module 1′ as described hereafter) that is 1.5-3.0 inches in singular length with stretchable elements that provide say, 3.0-6.0 inches in length, or may be laterally stacked (in differing multiples depending on the ultimate lengths required for a given application) on top of each other, with wheels or bullnoses 1″ used to reduce friction when transitioning or moving between lateral tubes. When structured as such, there is a serpentine usage of lateral space in which to store a substantially longer stretchable element on cord 1.

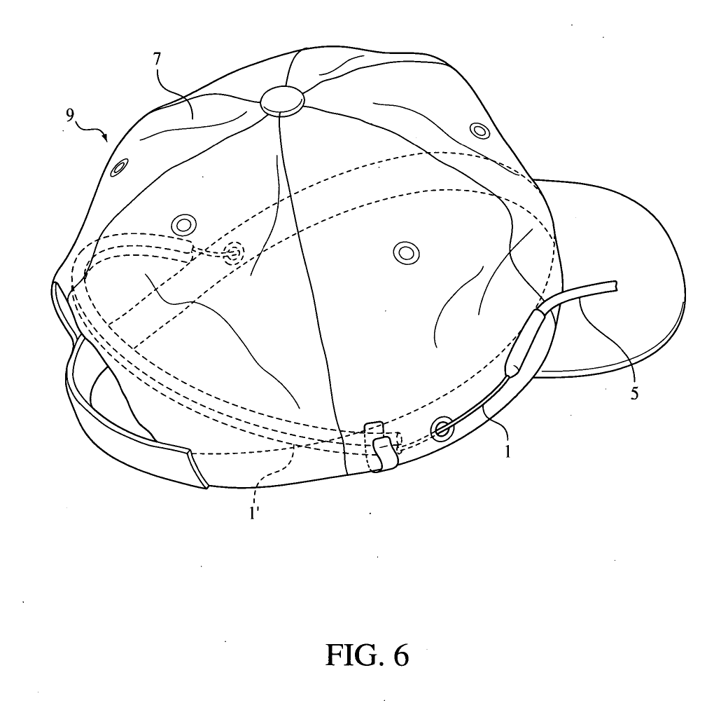

Thus, in one embodiment, the invention may additionally comprise a containment module 1′, which is most preferably formed from tubing 1′ so that it may be structured into a double-decker type barrel configuration for two separate cords 1 (as depicted in the exemplary illustrations found in FIGS. 5(a) and 6). As seen in exemplary FIG. 6, where just one version of the stretchable module and containment module 1′ is depicted, a lateral contiguous double barrel embodiment is configured, such that two separate tubes are molded or attached together to form one contiguous length that houses the first and second stretchable elements or cord(s) 1 in one preferred embodiment. Thus, in the lateral contiguous double barrel embodiment, there is an opening at a left end of the continuous double barrel tube for a first cord 1 to emanate from its respective housing. This opening, as depicted, is directly adjacent to the terminus for the other, coextensive second cord 1, wherein the second cord 1 is secured (by way of knotting, washer, rivet, etc.) so that it will not pull loose from the containment module 1′ when stretched. Similarly, there is an opening at the right end, for the second cord 1, which is directly adjacent to the terminus for the other, secured (by knotting, washer, rivet, etc. of) first cord 1. However, as can be appreciated, it is possible to configure the stretchable module 9 and the containment module 1′ as one single barrel for one or more cords 1 to be situated there in, or even as completely separated (e.g., bifurcated as in FIG. 5(c)) double or triple horizontally stacked or serpentine layers at each respective left and right sides, as further described herein.

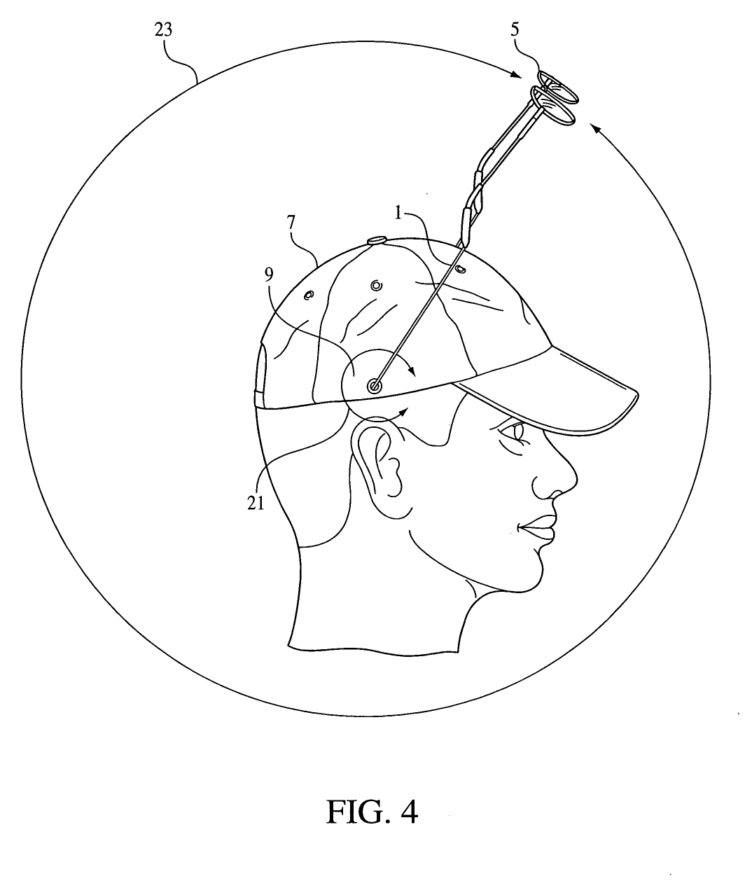

Whatever the specific configuration, the invention always provides, as seen in FIG. 4(a) for a (possible) 360 degree rotation about axis y at 27. The 360 degree access affords versatility so that a user may wear headgear in either direction while providing a constant, slight tension when in any given position, so that either headwear 7 or the user's face can be subjected to a slight pull so that the eyewear are maintained in place. As provided, stretchable module 9 may be affixed to headwear 7 through anchoring module 11 by a clip (as exemplarily depicted in FIG. 4(a), by a hook and loop securement, (such as the Velcro® brand product ((not depicted), or by headwear material integrated type structure (e.g., sewn, materially embedded in headwear such as plastic helmets, etc.) (not depicted), or otherwise affixed.

Furthermore, in providing the embodiments above, stretchable module 9 contains at least one (and most preferably two) stretchable element(s) or cord(s) 1, but in an especially preferred embodiment, may further comprise a containment module for housing said stretchable element(s). Hence, stretchable module 9 will preferably comprise a containment module 1′ for housing the stretchable element (e.g. cord 1) so that it will not become entangled, and so as to form a substantially continuous track that can aid in providing various levels of tensioning and stretching of the cord by distributing various vector forces more evenly. Stretchable module 9 may be made of any material, but could even simply be part of the headwear, it is preferably formed from plastic tubing (for containment module 1′), and “bungee”-type rubber cord (for stretchable element or cord 1). As for cord 1, it may be, as mentioned, formed of any material as known in the art, such as rubber, “bungee”-type material nylon or other material (such as a coil type spring, which may have elastomeric and/or non-elastomeric cord(s) 1 attached to its left and right ends), and may be of many lengths. The size of these two components may be of any dimensions (e.g., smaller for trim headgear such as baseball cap used with sunglasses, and larger for heavy duty gear, such as construction or other helmets used with say, safety goggles). Nevertheless, in a typical embodiment (such as the contiguous lateral double barrel type containment module 1′ embodiment illustrated in FIG. 6) will be slim plastic tubing (perhaps ⅛ inches for say, a baseball cap), while the stretchable element(s) 1 of the stretchable module 1 will be say, 1/32- 1/16 inches thick and will range from 3 inches (for child size versions of caps) to 8 inches (one preferred length for adult baseball caps) to 16 inches in length for heavy duty versions (helmets, etc.) and will be able to expand to say, ideally 100-110% of its original length to achieve approximately 9-12″ of additional length by stretching. As one skilled in the art can appreciate, however, these dimensions may be different where for example, different headgear and/or eyewear is used, and will further depend on whether the stretchable module 9 is not contiguous, but is bifurcated into separate left and right modules as described above, or where different containment module structures (such as the layered lateral barrels, also described above) are provided.

Stretchable module 9 may be situated or affixed to headgear 7 almost anywhere that is a functionally suitable and comfortable part of headgear 7 as a user might wear it, but this of course will vary depending on the type of headgear (e.g. light gauge hats compared to heavy duty helmets), and depending on the positioning of the headgear (e.g., some hats may be worn frontwards or backwards. In addition, depending on how the containment module 1′ is configured (e.g. bifurcated, lateral double barrel, multiple lateral double barrel, etc.), the positioning will be affected. As such, depending on the type of application of the eyewear retention device, it may be best to situate stretchable module 9 substantially central, or even perhaps, predominantly forward or backward to the hat, depending on primary orientation). When provided as such, the invention offers the user maximum flexibility so that he may wear his headgear either backwards or frontwards, while still being able to utilize the eyewear retention device without necessarily removing it.

Turning back then to FIGS. 5(a) and 5(b), are exemplary depictions of the above described eyewear retention device by itself and situated on the exemplary headgear 7 (in this case, as secured by exemplary clips, which may be particularly useful as an aftermarket add-on to a favorite piece of headgear, or alternatively, for helmets). Furthermore, by way of just one example, FIG. 6 depicts one of the several positions in which the eyewear retention device may be fitted comfortably inside headgear 7. As can be appreciated, the actual placement may be fully horizontal so as to coincide substantially with a sweatband of a given headwear, or may be positioned forward, or otherwise (as shown in the exemplary depiction of FIG. 6) in order to accommodate the specific structure of the headwear 7.

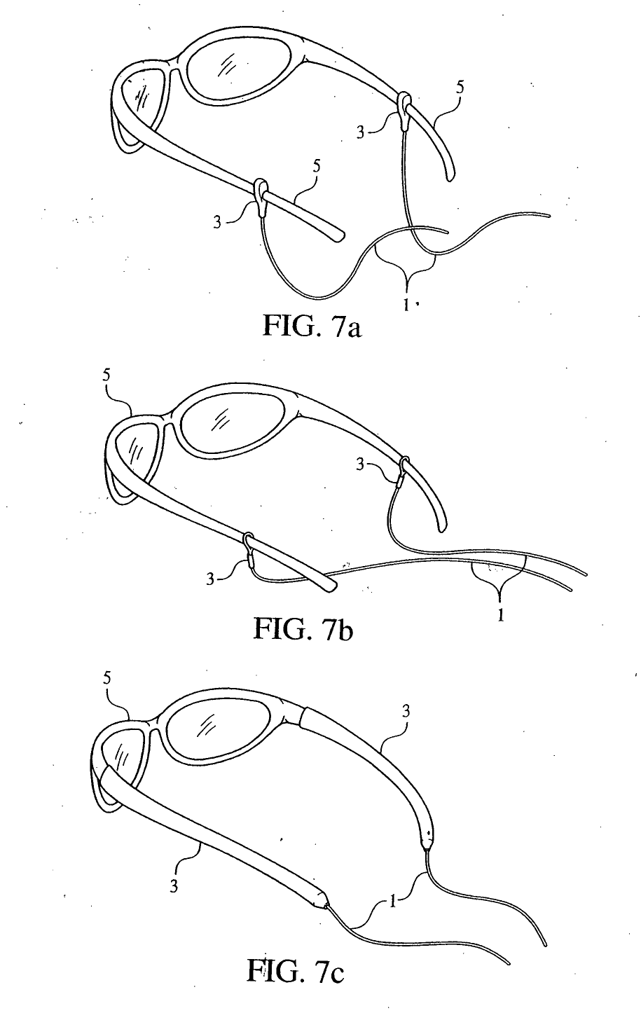

Lastly, an eyewear frame attachment portion 3 is provided at the left and the right ends of the stretchable elements or cord(s) 1 for attachment to an article of eyewear 5. As illustratively depicted in FIG. 7, the eyewear frame attachment portion 3 may be of many types, whether a clamping slot type as seen in FIG. 7(a), or whether a simple “noose” type as seen in FIG. 7(b), or whether of an elastic (e.g., neoprene, spandex, rubber, etc.), or non-elastic (plastic, polyester, metallic, etc.) sleeve type as seen in FIG. 7(c), or other (non-depicted) types such as snaps, etc.

The foregoing description of the specific embodiments reveals the general nature of the invention such that others can—by applying current knowledge—readily modify and/or adapt for various applications such specific embodiments without departing from the generic concept, and therefore, such adaptations and modifications should and are intended to be comprehended within the meaning and range of equivalents of the disclosed embodiments. It is to be understood that the phraseology or terminology employed herein is for the purpose of description and not of limitation. The means and materials for carrying out various disclosed functions may take a variety of alternative forms without departing from the invention. It is to be understood that the invention is not limited to the illustrations described and shown herein, which are deemed to be more illustrative of the best modes of carrying out the invention, and which are susceptible of modification of form, size, arrangement of parts and details of operation. Hence, all such modifications are within the spirit and scope of the appended claims.

1. An eyewear retention device comprising:
a stretchable module having a left end and a right end;
an eyewear frame attachment portion at said left and at said right end for attachment to an article of eyewear; and
at least one anchoring module for anchoring the stretchable module to an article of headwear.

2. The eyewear retention device according to claim 1, further comprising:
a containment module for housing said stretchable module, wherein said stretchable module is constrained within said containment module so as to permit various levels of tensioning and stretching of said stretchable module.

3. The eyewear retention device according to claim 2, wherein the anchoring module is formed from the group comprising clips, headwear integrated structures, or hook and loop fasteners.

4. The eyewear retention device according to claim 3, wherein the containment module comprises at least one tube for containing said stretchable module.

5. The eyewear retention device according to claim 4, wherein said stretchable module comprises at least one stretchable element, said stretchable element being formed from at least one material chosen from the group comprising an elastomeric material or a spring coil.

6. The eyewear retention device according to claim 5, wherein said stretchable module is formed so as to provide a substantially constant inward tension of said at least one stretchable element.

7. The eyewear retention device according to claim 6, wherein said at least one stretchable element comprises a left stretchable element and a right stretchable element, each having a length between 1.5 to 7 inches in length.

8. The eyewear retention device according to claim 7, wherein said at least one stretchable element is formed from a bungee-type material.

9. The eyewear retention device according to claim 7, wherein said at least one stretchable element is formed from a spring coil type material.

10. The eyewear retention device according to claim 8, wherein said anchoring module is formed from a clip type material.

11. The eyewear retention device according to claim 8, wherein said anchoring module is formed from a headwear integrated type structure.

12. The eyewear retention device according to claim 8, wherein said anchoring module is formed from a hook and loop fastener.

13. The eyewear retention device according to claim 8, wherein said stretchable module is bifurcated into a left and a right section.

14. The eyewear retention device according to claim 13, wherein said stretchable module is single barrel layered in structure.

15. The eyewear retention device according to claim 13, wherein said stretchable module is multiple barrel layered in structure.

16. The eyewear retention device according to claim 9, wherein said stretchable module further includes an elastomeric material attached to a left end and to a right end of said spring coil type material.

17. The eyewear retention device according to claim 9, wherein said stretchable module further includes a non-elastomeric material attached to a left end and to a right end of said spring coil type material.

18. The eyewear retention device according to claim 4, wherein said stretchable module is contiguous double barrel layered in structure.

19. An eyewear retention device comprising:
a stretchable module having a left end and a right end, wherein said stretchable module comprises two separate stretchable elements, said stretchable elements being formed from at least one material chosen from the group comprising an elastomeric material or a spring coil;
an eyewear frame attachment portion at said left and at said right end for attachment to an article of eyewear, and
an anchoring module for anchoring the two separate stretchable elements of said stretchable module to an article of headwear.
